(19) United States
(12) Patent Application Publication
(10) Pub. No.: US 2022/0130315 A1
(43) Pub. Date: Apr. 28, 2022

(54) SELECTION OF COLOR CALIBRATION PROFILE DATA FROM DISPLAY MEMORY

(71) Applicant: Hewlett-Packard Development Company, L.P., Spring, TX (US)

(72) Inventors: Thong Thai, Spring, CA (US); Gregory Staten, Spring, TX (US); Alan Tam, Spring, TX (US)

(73) Assignee: Hewlett-Packard Development Company, L.P., Spring, TX (US)

(21) Appl. No.: 17/419,268

(22) PCT Filed: Jul. 16, 2019
(86) PCT No.: PCT/US2019/041930

§ 371 Date: Jun. 28, 2021

(51) Int. Cl. G09G 3/20; G06T 1/20

(52) U.S. Cl. CPC G09G 3/2003; G06T 1/20; G09G 2320/0693; G09G 2320/0242; G09G 2320/0233; G09G 2310/08

(57) ABSTRACT

In various examples, a display may include memory storing a plurality of color calibration profiles corresponding to a plurality of display modes, and logic operably coupled with the memory. The logic may determine a current display mode of the display, e.g., based on a signal received from a computing device operably coupled with the display. Based on the current display mode of the display, the logic may select a given color calibration profile from the plurality of color calibration profiles. The logic may then render an image on the display using the selected given color calibration profile.

### BACKGROUND

Some computer displays can render visual content in multiple different target luminosity ranges, such as standard dynamic range (“SDR”) and high dynamic range (“HDR”). HDR enables a greater dynamic range of luminosity than SDR, and is often used by video/film compositors and color graders, animation lighters, and photographers to better represent the range of contrast found in the real world or to create exaggerated representations for mood or impact. It is also used by gamers and consumers to engage with and view HDR content created by game studios and content providers. Some displays support multiple SDR and/or HDR modes. For example, a standard SDR mode may be used for tasks such as web browsing, a wide gamut SDR mode may be used for tasks such as photo editing. Some SDR/HDR modes may have different white points for video (e.g., D65) versus for print (e.g., D50).

### BRIEF DESCRIPTION OF THE DRAWINGS

Features of the present disclosure are illustrated by way of example and not limited in the following figure(s), in which like numerals indicate like elements.

FIG. 1 is a drawing of an example environment in which selected aspects of the present disclosure may be implemented.

FIG. 2 schematically depicts an example of how various components configured with selected aspects of the present disclosure may interact.

FIG. 3 schematically demonstrates how techniques described herein may impact timelines of computer activation according to an example.

FIG. 4 schematically depicts an example of a hardware architecture that may be used to implement selected aspects of the present disclosure.

FIG. 5 depicts an example method of practicing selected aspects of the present disclosure.

### DETAILED DESCRIPTION

For simplicity and illustrative purposes, the present disclosure is described by referring mainly to an example thereof. In the following description, numerous specific details are set forth in order to provide a thorough understanding of the present disclosure. The present disclosure may be practiced without limitation to these specific details. In other instances, some methods and structures have not been described in detail so as not to unnecessarily obscure the present disclosure.

The elements depicted in the accompanying figures may include additional components and that some of the components described in those figures may be removed and/or modified without departing from scopes of the elements disclosed herein. It should also be understood that the elements depicted in the figures may not be drawn to scale and thus, the elements may have different sizes and/or configurations other than as shown in the figures.

A graphics processing unit (“GPU”) is a type of logic that is specifically designed to render graphics on a display, often more efficiently and/or powerfully than a standard central processing unit (“CPU”). Many GPUs are capable of switching between multiple different luminosity ranges. However, as battery-powered devices such as laptop computers and tablet computers have become more powerful, their popularity among graphics enthusiasts has also grown. However, constantly operating a GPU to switch between and/or implement multiple different luminosity ranges uses considerable power, in some instances incurring a battery life penalty of 50%. Accordingly, techniques are described herein for delegating luminosity range control and/or switching away from a GPU, e.g., to logic integral with a display. Consequently, the GPU may be powered for less time, which may conserve battery power.

In various implementations, a memory of a display may be used to store multiple color calibration profiles that correspond to a plurality of luminosity ranges or “display modes,” such as HDR, SDR, etc. A color calibration profile stored in the display's memory may take various forms. In some examples, the color calibration profile may take the form of a pre-lookup-table (“Pre-LUT”), a multiply matrix (e.g., 3×3), and a post-LUT—in that order in many cases. In other examples, the color calibration profile may take the form of a shaper LUT followed by a three-dimensional (“3D”) LUT.

The display may also include logic such as a timing controller (“TCON”) or scaler chip. This logic may select a color calibration profile from the plurality of color calibration profiles based on a current display mode to be implemented by the display. The logic may then program the color calibration profile into a portion of memory integral with the display that is referred to herein as the “color block.” In some examples, by commandeering the display logic to load and/or implement a target color calibration profile, it is possible to calibrate the display to a target luminosity range prior to the display actually rendering content. Consequently, a user doesn't witness an abrupt color change or flickering as the display switches from one color calibration profile to another.

The current display mode may be determined in various ways. In some examples, the current display mode may be determined based on a signal received at the display from a computing device. The signal may be, for instance, metadata that accompanies graphics data, an operating system signal, an application-specific signal (e.g., from a gaming or graphics manipulation application), and so forth. In some examples a user may explicitly select a desired luminosity range or display mode. However, in many other examples, the signal may be received from the computing device without the user having any knowledge of it.

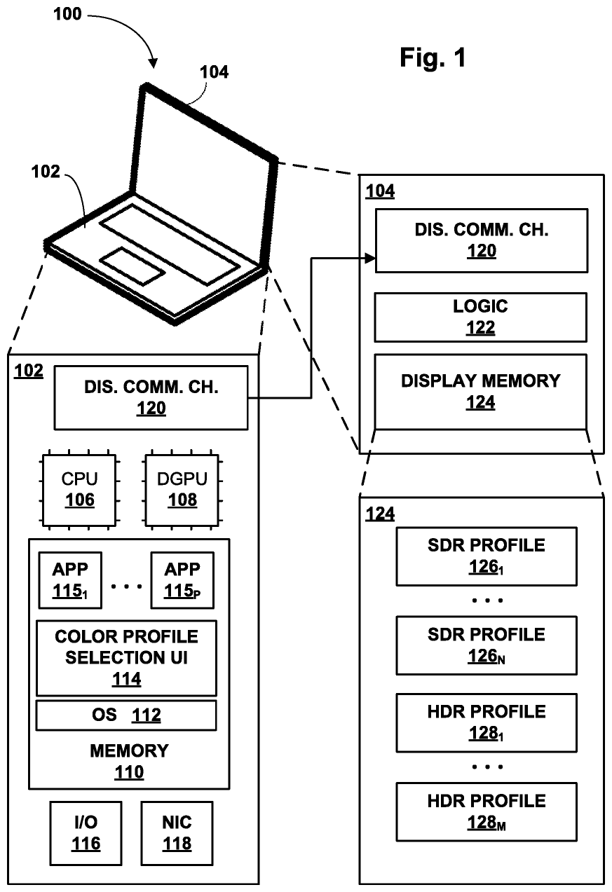

Referring now to FIG. 1, an example computing system 100 is depicted in the form of a laptop computer that includes a computing device 102 or “host” operably coupled with a display 104. In this example, computing device 102 and display 104 are integrated together as a single unit. Display 104 can be, for instance, pivoted about various angles relative to computing device 102. However, this is not meant to be limiting. In other examples, computing device 102 may be a standalone computing device such as a tower, and display 104 may be a standalone display.

In yet other examples, computing system 100 may be formed as a tablet computer or an “all-in-one” computing system in which display 104 and computing device 102 are integrated into a single unit. In yet other examples, computing system 100 in general and/or display 104 in particular may take the form of a head-mounted display (“HMD”) that provides an augmented reality (“AR”) or virtual reality (“VR”) experience to a wearer.

As shown in the exploded portion at bottom left, computing device 102 may include logic in the form of a CPU 106 and a GPU 108. As shown in FIG. 1, in some examples, GPU 108 may be a “discrete” GPU that is separate and independent from CPU 106. In other examples, the functionalities of CPU 106 and GPU 108 may be combined into a single unit, such as a CPU with integrated graphics. CPU 106 and/or GPU 108 may be operably coupled with various types of memory, collectively represented by memory 110 in FIG. 1. Memory 110 may include, for instance, read-only memory or “ROM,” random access memory or “RAM,” various types of non-volatile memory, etc.

Memory 110 may include, e.g., in the form of computer-executable instructions loaded in RAM from non-volatile memory, an operating system (“OS” in FIG. 1) 112, a color profile selection user interface (“UI”) 114, and various applications 1151-P that may execute on top of operating system 112. Color profile selection user interface 114 may be a special application that receives user input to manually select which color calibration profile they would like to use on display 104. The user input may take various forms, such as user selection of a graphical element of a graphical user interface (“GUI”), a voice command, a gesture, etc. In other examples, color profile selection user interface 114 may be omitted, and color profile selection may be performed “behind the scenes,” e.g., using source content metadata without the user being aware of it happening.

Among other things, applications 1151-P may include graphics intensive applications and therefore may utilize multiple different luminosity ranges and/or display modes of display 104. Such graphics-intensive applications may include, for instance, video games, photo editors, animation editors, graphic design applications, movie editors, computer-aided design (“CAD”) applications, image compositing applications, color grading applications, and so forth.

Computing device 102 may also include other components commonly found in computing devices. As non-limited examples, in FIG. 1, computing device includes input/output (“I/O”) interface(s) 116 and a network interface card (“NIC”) 118. I/O interface(s) 116 may include, for instance, a keyboard, mouse, microphone, digital camera, etc.

In some examples, a display communication (“COMM.” in FIG. 1) channel(s) 120 may also be part of I/O interface(s), although it is depicted separately in FIG. 1. Display communication channel(s) may take various forms, such as Video Graphics Array (“VGA”), Digital Visual Interface (“DVI”), High-Definition Multimedia Interface (“HDMI”), DisplayPort (“DP”) and/or Embedded DisplayPort (“eDP”), Low-Voltage Differential Signaling (“LVDS”), V-by-One, Universal Serial Bus (“USB”), Display Data Channel Connection Interface (“DDC/CI”), Inter-Integrated Channel (“I²C”), Auxiliary Interface (“AUX”), etc. As shown in FIG. 1, display communication channel(s) 120 may operably couple computing device 102 with display 104.

Display 104 may include display logic 122 and display memory 124. Display logic 122 may take various forms, such as a timing controller (“TCON”), a scaler chip or controller, a field-programmable gate array (“FPGA”), and/or an application-specific integrated circuit (“ASIC”). Display memory 124 may take various forms as well, such as those previously mentioned, as well as electrically erasable programmable read-only memory (“EEPROM”), NAND or NOR flash memory, etc.

Display memory 124 may store a plurality of color calibration profiles (or simply “color profiles”) corresponding to a plurality of display modes or luminosity ranges. In FIG. 1, for instance, display memory 124 stores a plurality of SDR color calibration profiles 126_{1-N} and a plurality of HDR color calibration profiles 128_{1-M}. In other examples, display memory 124 may store multiple SDR color calibration profiles 126_{1-N} and one HDR color calibration profile 128. Alternatively, in some examples, display memory 124 may store one SDR color calibration profile 126 and multiple HDR color calibration profiles 128_{1-M}.

In various examples, display logic 122 may determine, e.g., based on a signal received from computing device 102, a current display mode of display 104. For example, on power-up, operating system 112 may send a signal to display logic 122 over display communication channel 120. This signal may include display mode information that indicates which display mode display 104 is supposed to operate in. Display mode information may be contained in various locations of an operating system message, such as in a packet header, video content data, etc. Based on the current display mode of display 104, display logic 122 may select a given color calibration profile from the plurality of color calibration profiles 126_{1-N}, 128_{1-M} stored in display memory 124. Using the selected given color calibration profile, display logic 122 may render image(s) on display 104.

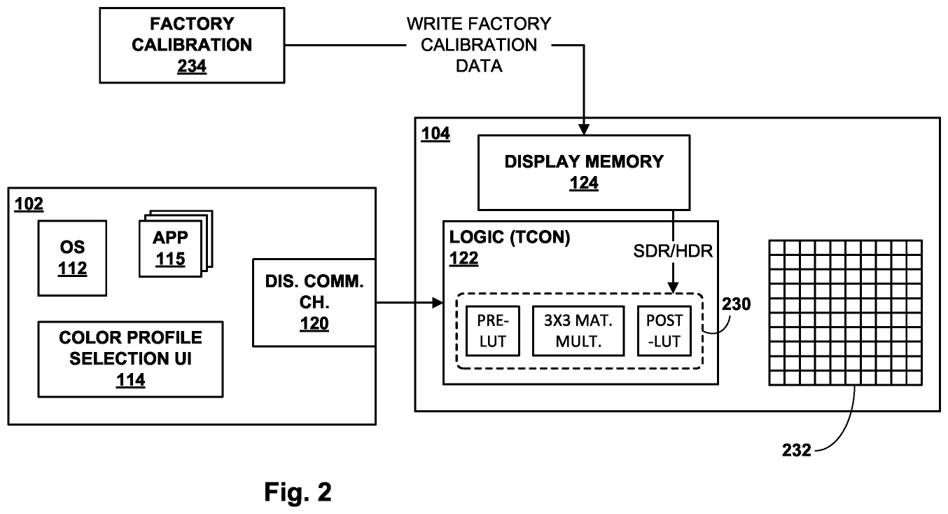

FIG. 2 schematically depicts an example of how various components configured with selected aspects of the present disclosure may interact. Starting a top, a factory calibration module 234 may be operated at a factory that manufactures display 104. Factory calibration module 234 may be operated, e.g., by factory personnel, to input data gleaned from manual testing of luminosity range capabilities of each individual display 104. This “factory calibration data” may include, for instance, the color calibration profiles 126_{1-N} and 128_{1-M} depicted in FIG. 1. It may be written to display memory 124 at the factory, e.g., before display 104 is shipped to a retailer, distributor, consumer, etc.

Also depicted in FIG. 2 as part of display 104 is a color block 230 and a two-dimensional matrix of pixels 232. In this example, operating system 112, an application 115, and/or color profile selection user interface 114 may send a signal to display logic 122 (which may be, for instance, a TCON) via display communication channel 120. This signal may indicate which display mode or luminosity range should be implemented by display 104 when rendering content on matrix of pixels 232. Thus, the signal may cause display logic 122 to select, from display memory 124, a color calibration profile (e.g., SDR/HDR) to implement.

The selected color calibration profile may be stored or “programmed” as a color block 230. Color block 230 may be, for instance, a memory location(s) that are particularly fast, such as memory registers, flash memory, EERPOM, etc. In FIG. 2, the color calibration profile takes the form of a Pre-LUT, a multiply matrix (e.g., 3×3), and a post-LUT. In other examples, the color calibration profile stored as color block 230 may take other forms, such as a shaper LUT followed by a three-dimensional (“3D”) LUT.

In various examples, display logic 122 may calibrate vision data to be rendered on matrix of pixels 232 in real time using the content of color block 230. Notably, storing the color calibration profile as color block 230 on display 104, rather than the color block being implemented by GPU 108 (or CPU 106), may conserve considerable computing resources of computing device 102, particular battery power if computing system 100 is a portable or mobile computing system.

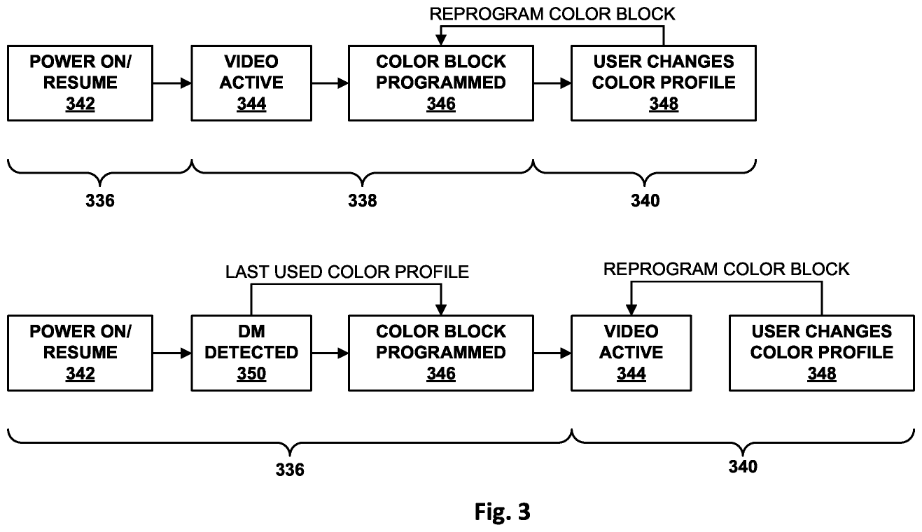

FIG. 3 demonstrates how techniques described herein, in addition to conserving computing resources such as battery power, may also improve a user's experience in other ways. In particular, FIG. 3 demonstrates how techniques described herein avoid visible image changes, such as flickering, on display 104 during a time interval after a computing system is powered up, awoken from a sleep state, etc. Two timelines are depicted, with time running from left to right.

The timeline at top begins at 342 when a computing device 102 is powered on, resumed, or otherwise activated. The interval 336 represents a time interval during which no content is rendered on display 104. At 344, video becomes active, and display 104 begins rendering content.

During the interval 338, content is rendered on display 104, but it is not yet known what display mode or luminosity range is supposed to be implemented by display 104. Consequently, the rendered content may exhibit various visible changes. For example, the visual content may be initially rendered using a default color calibration profile, such as an SDR profile. However, at 346, the color block (230) may be programmed, e.g., with an HDR profile. As a result, the user may perceive a visible change in the visual content rendered on display 104, which may not stabilize until color block 230 is programmed. Once color block 230 is programmed, a new interval 340 begins during which the visual content rendered on display 104 may be stable.

However, a user may subsequently select a new color profile at 348, e.g., using color profile selection UI 114. This may cause a transition back into the instability exhibited during interval 338. In particular, when color block 230 is reprogrammed with the user-selected color calibration profile, the user may perceive another visible change in visual content rendered on display 104.

The timeline at bottom of FIG. 3 implements techniques described herein to reduce or eliminate the visible changes (e.g., flickering) that would be observable with the top timeline in FIG. 3. In particular, color block 230 is programmed prior to visual content being rendered on display 104. The timeline at bottom begins similar as that at top—at 342 the computing device 102 is powered up, resumed, or otherwise activated.

Unlike the top timeline, however, in the bottom timeline the next phase is not activation of video such that display 104 begins rendering content. Rather, before any visual content is rendered on display, at 350, a display mode (or target luminosity range) may be detected, e.g., by display logic 122 from a signal received from computing device 102.

At 346, based on the detected display mode, and prior to anything being rendering on display 104, color block 230 may be programmed, e.g., by display logic 122. In some examples, if the detected display mode is SDR, then the last-used SDR color profile, or a default SDR color profile, may be programmed into color block 230.

Alternatively, if the detected display mode is HDR, then in some examples, a specific color preset configuration—for example, the International Telecommunications Union Recommendation (“ITU-R”) BT.2020 color gamut and the Society of Motion Picture and Television Engineers Standard (SMPTE ST) 2084 Electro-Optical Transfer Function (“EOTF”)—may be programmed into color block 230. In other examples in which the detected display mode is HDR, the last-used HDR color profile may be programmed into color block 230. In other examples in which the detected display mode is HDR, the last-used HDR color profile may be programmed into color block 230.

Referring back to the bottom timeline of FIG. 3, once color block 230 is programmed, at 344, video becomes active, and display 104 begins rendering content. In this example color block 230 is already programmed. Consequently, the user will perceive fewer, if any, visual artifacts. At 348, the user may change the color profile, e.g., using color profile selection UI 114, which causes display logic 122 to reprogram color block 230.

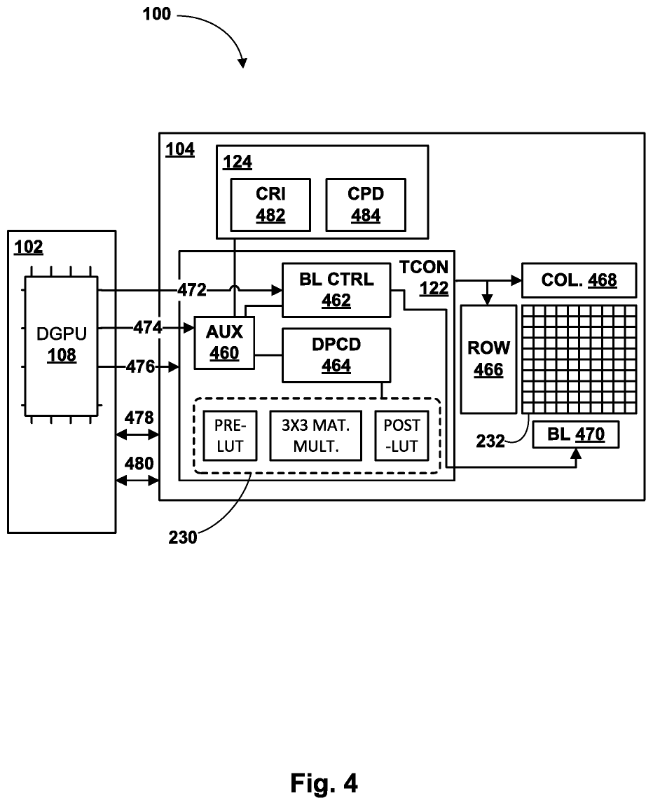

FIG. 4 schematically depicts, in relatively greater detail than previous figures, an example hardware architecture that may be implemented on display 104, in accordance with various examples. Computing device 102 is also depicted, but with most components of computing device 102 other than GPU 108 omitted for the sake of clarity.

In FIG. 4, display logic 122 takes the form of a TCON that includes, among other things, an auxiliary (“AUX”) interface 460, a backlight (“BL”) controller (“CTRL”) 462, and a device controller 464. In FIG. 4, device controller 464 takes the form of a DisplayPort Configuration Data (“DPCD”) controller but this is not meant to be limiting.

Matrix of pixels 232 is controlled in part by a plurality of row drivers 466 and a plurality of column drivers 468. Row drivers 466 and column drivers 468 are in turn controlled by TCON 122, as indicated by the arrows. Backlight controller 462 is operably coupled to, and thereby controls, a backlight (“BL”) 470.

GPU 108 is operably coupled with components of TCON 122 via a variety of communication interfaces, any of which may share aspects with display communication channel 120 in FIG. 1. TCON 122 (or more generally, display logic 122) may detect the current and/or target display mode (or luminosity range) of display 104 via data transmitted via any of these communication interfaces. In FIG. 4, GPU 108 is operably coupled with backlight controller 462 via a backlight control interface 472. GPU is operably coupled with auxiliary interface via an auxiliary control interface 474. And GPU is further operably coupled with TCON 122 via a main link 476. Main link 476 may be used, for instance, to transmit graphics data from GPU 108 to TCON 122 so that TCON 122 can render visual content on matrix of pixels 232.

In some examples, other communication interfaces may be provided between computing device 102 generally (not specifically from GPU 108) and display 104. The display mode of display 104 may be detected in these interfaces as well. These additional interfaces may include, for instance, a general-purpose input/output (“GPIO”) interface 478 and/or an Inter-Integrated Circuit (“I²C”) interface 480. In some examples, GPIO interface 478 and/or I²C interface 480 may be used to transmit, from computing device 102 to display 104, a command to disable or bypass color block 230, e.g., to facilitate a native luminosity range of display 104.

In FIG. 4, display memory 124 includes computer-readable instructions (“CRI”) 482 and color profile data (“CPD”) 484. Color profile data 484 may include, for instance, the color profiles 126_{1-N} and 128_{1-M} described previously. Computer-readable instructions 482 may be, for instance, firmware instructions that are executed by TCON 122, e.g., by way of device controller 464. These instructions may cause TCON to perform selected aspects of the present disclosure, such as detecting a target display mode or luminosity range of display 104, selecting a color calibration profile from color profile data 484 based on the detected target display mode, and programming the selected color calibration profile into color block 230. In some examples, computer-readable instructions 482 may also include, or have access to once executed, extended display identification data (“EDID”).

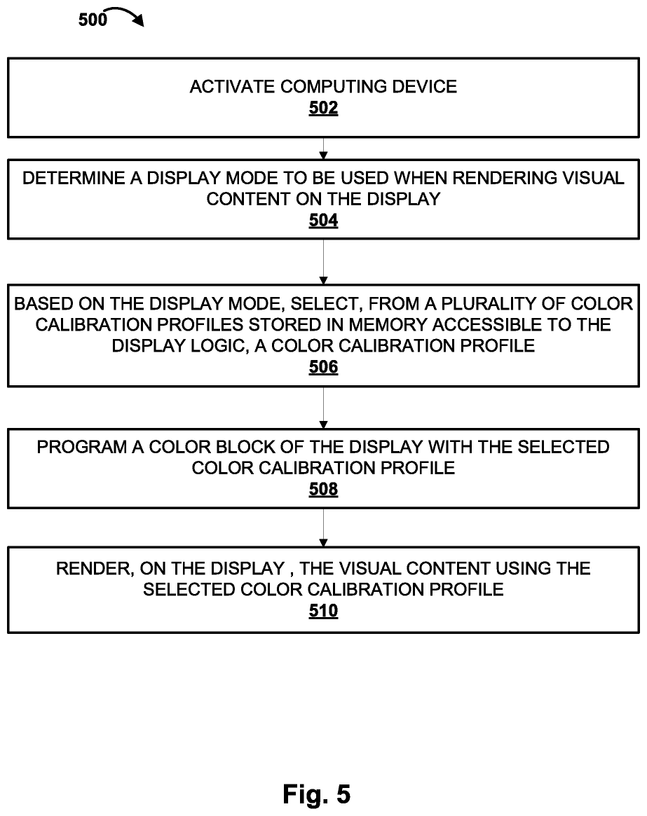

FIG. 5 depicts an example method 500 of practicing selected aspects of the present disclosure. For convenience, operations of method 500 will be described as being performed by a logic configured with selected aspects of the present disclosure, such as display logic 122. The operations in FIG. 5 are not meant to be limiting; various operations may be added, omitted, and/or reordered.

At block 502, the computing device 102 may be activated. For example, it may be powered on, “awakened” from a sleep mode, or otherwise activated in a manner that visual content will begin to be rendered on matrix of pixels 232.

At block 504, the logic may determine a display mode (or luminosity range) to be used when rendering visual content on the display. This display mode may be detected by the logic in various signals received at various interfaces (e.g., 472-480). In some examples, the signal received from the computing device that conveys the display mode is contained in metadata associated with graphics data received from computing device 102. In some examples, the signal takes the form of an operating system signal received from operating system 112. In some examples, the signal is part of an application signal received from an application 115 executing on computing device 102. In some examples, the signal may be a signal received from GPU 108, which may be a dedicated GPU and/or integrated with CPU 106.

The “visual content” may take various forms. In some instances it may be a GUI of a graphics-intensive application such as a photo editor, video editor, graphics design application, etc. In some instances the visual content may be a video game interface. In some instances the visual content may take the form of an audio visual presentation that utilizes a wide range of luminosity values.

Based on the display mode, at block 506, the logic may select, from a plurality of color calibration profiles (e.g., 126_{1-N}, 128_{1-M}) stored in display memory 124 accessible to the logic, a color calibration profile. As noted previously, these color calibration profiles may be stored in various types of memory integral with display 104, such as EEPROM. At block 508, the logic may program color block 230 of display 104 with the color calibration profile selected at block 506. In some examples, this may occur prior to block 510, at which point the logic may render, e.g., on matrix of pixels 232, the visual content using the selected color calibration profile.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What is claimed is:

1. A display comprising:
memory storing a plurality of color calibration profiles corresponding to a plurality of display modes; and
logic operably coupled with the memory, the logic to:
determine, based on a signal received from a computing device operably coupled with the display, a current display mode of the display;
select, based on the current display mode of the display, a given color calibration profile from the plurality of color calibration profiles; and
render an image on the display using the selected given color calibration profile.

2. The display of claim 1, wherein the logic comprises a timing controller (“TCON”) integral with the display.

3. The display of claim 1, wherein the logic comprises a scaler chip integral with the display.

4. The display of claim 1, wherein a first of the plurality of color calibration profiles corresponds to a standard dynamic range (“SDR”) display mode and a second of the plurality of color calibration profiles corresponds to a high dynamic range (“HDR”) display mode.

5. The display of claim 1, wherein the signal received from the computing device is contained in metadata associated with graphics data received from the computing device.

6. The display of claim 1, wherein the signal received from the computing device comprises an operating system signal received from an operating system executing on the computing device.

7. The display of claim 1, wherein the signal received from the computing device comprises an application signal received from an application executing on the computing device.

8. The display of claim 1, wherein the signal received from the computing device comprises a signal received from a graphics processing unit (“GPU”) of the computing device.

9. The display of claim 1, wherein the logic is to select the given color calibration profile before it renders the image.

10. A computing system comprising:
a computing device comprising a processor operably coupled with a display communication channel; and
a display comprising display memory storing a plurality of color calibration profiles associated with a plurality of luminosity ranges, and display logic operably coupled with the display memory and with the display communication channel, the display logic to:
receive, via the display communication channel, data indicative of a target luminosity range of the plurality of luminosity ranges;
based on the target luminosity range, select a color calibration profile from the display memory; and
render an image on the display based on the selected color calibration profile.

11. The computing system of claim 10, wherein the computing system comprises a laptop computer.

12. The computing system of claim 10, wherein the display communication channel comprises an auxiliary channel.

13. The computing system of claim 10, wherein the plurality of color calibration profiles include a standard dynamic range (“SDR”) color calibration profile and a high dynamic range (“HDR”) color calibration profile.

14. A method implemented using a timing controller (“TCON”) integral with a display, comprising:
determining, by the TCON, a display mode to be used when rendering visual content on the display;
based on the display mode, selecting, by the TCON from a plurality of color calibration profiles stored in memory accessible to the TCON, a color calibration profile; and
rendering, on the display by the TCON, the visual content using the selected color calibration profile.

15. The method of claim 14, wherein the determining is performed by the TCON in response to activation of a computing device that generates the visual content for rendition on the display, and wherein the method further includes:
programming, by the TCON, a color block of the display with the selected color calibration profile prior to the rendering.
